(19) United States
(12) Patent Application Publication
(10) Pub. No.: US 2026/0000050 A1
(43) Pub. Date: Jan. 1, 2026

(54) MULTI-LAYER MODULAR PET BED

(71) Applicant: Tina Russ, Jacksonville, FL (US)

(72) Inventor: Tina Russ, Jacksonville, FL (US)

(21) Appl. No.: 19/334,603

(22) Filed: Sep. 19, 2025

Related U.S. Application Data
(63) Continuation-in-part of application No. 17/155,745, filed on Jan. 22, 2021, now abandoned.
(60) Provisional application No. 63/040,320, filed on Jun. 17, 2020.

(51) Int. Cl. A01K 1/035

(52) U.S. Cl. CPC A01K 1/0353

(57) ABSTRACT

A multi-layer modular pet bed includes a foldable outer layer, at least one foldable inner layer, and an attachment means for securing the layers together to form a pet bed. In one embodiment, the foldable inner layer has a slightly smaller perimeter than the outer layer and sits within the outer layer so that, when folded and secured, a compact cushioned bed is formed. In another embodiment, the outer layer includes a perimeter zipper and one or more inner layers that are wholly detached from the outer layer, such that the detached layers are positioned on the outer layer and sandwiched therein when the zipper is closed. This configuration allows the bed to be broken down into separate panels for washing or for use as blankets. Optional features include removable protective covers and additional cushioning material positioned within one or more layers.

### CROSS REFERENCE TO RELATED APPLICATIONS

This application is a continuation-in-part of U.S. patent application Ser. No. 17/155,745, filed Jan. 22, 2021, entitled “Multi-Layer Modular Pet Bed,” which claims the benefit of priority to U.S. Provisional Patent Application Ser. No. 63/040,320, filed Jun. 17, 2020, entitled “A Multi-Layer Blanket With a Zipper Attachment That When Folded and Zipped Shut Creates a Fully Encased Cushion Like Pillow.” The disclosures of the foregoing applications are hereby incorporated by reference in their entireties.

### BACKGROUND OF THE INVENTION

The present invention relates generally to a multi-layer modular pet bed which allows for ease of cleaning. More specifically, the present invention includes a foldable pet bed that is adapted to be spread out like a blanket, or to be folded up and zipped or otherwise attached in a compact state to form a multi-layer pet bed. The pet bed, in its compact, folded configuration includes an outer layer, a foldable inner layer, and an attachment means, such as a zipper, to secure the outer and inner layers together and form a bed or cushion.

Pet beds and cushions have been used for many years for the comfort of both animals and humans alike. Typically, pet beds are difficult to wash in traditional washing machines due to their size and bulk, which often results in disposal of soiled beds.

Some examples of modular pet beds are set forth hereinbelow, and each of the following references are incorporated herein by reference, in their entireties:

U.S. Pat. No. 4,985,952—Flexibly Hinged Convertible Mattress

Four rectangular cushion sections are flexibly interconnected along certain of their top and bottom edges by three hinges. The resulting mattress-like article may be variously folded and unfolded to function as a bed, exercise mat, day couch, or ottoman, and can also be compactly stored.

U.S. Pat. No. 5,144,911—Component Bed System for a Pet

A component bed system for a pet is provided and consists of a mattress pad, an inner liner around the mattress pad, a cover to fit about the inner liner on the mattress pad and a mat placed upon the cover so that the pet can recline and sleep thereon in comfort.

U.S. Pat. No. 5,611,414—Self-Contained Folding Portable Bed

The invention describes a bed in a suitcase requiring minimal preparation for use. It is intended for storage in, for example, a car or truck, and for use when the driver may not be in a condition to drive home. The bed is formed by mating a foldable mattress or pallet with bed clothing, such as an undersheet with a half-width sleeping bag cover. The foldable mattress has a number of cushioning elements which can be folded, especially when used in conjunction with material hinges, to fit within the suitcase. The cushions may also be extended to lie side by side in an extended position for sleeping. Some or all of those elements may have a hard shell mounted to their undersides to protect the mattress from broken glass or sharp objects. The suitcase and hard shell materials are resistant to water absorption and the bed clothing is removable and washable.

U.S. Pat. No. 5,639,145—Portable Cushion

A portable, flexible cushion disclosed utilizes layers of different foam plastic materials secured together at contacting faces. The cushion combines closed cell and open cell foam plastic material features and a hinged construction providing reversibility and can be used in right angle and flat end to end applications. Optionally, vibrators are received in openings in the panels for therapeutic purposes. Different combinations of the closed and open cell materials are particularly suitable for wet and dry applications.

U.S. Pat. No. 6,026,525—Foldable Infant Mattress System With Sleeping Recess

A foldable infant mattress system with a sleeping recess. A head mattress section is hingedly connected to a foot mattress section. Each mattress sections include an end wall and two laterally spaced apart sidewalls traversed to the end wall. The foldable infant mattress system is deployed in a flat position for sleeping and foldable into a closed position for carrying. In the flat position, the end wall and sidewalls of each mattress section together form the recess which contains an infant to a sleeping area. The walls are of sufficient thickness to allow for sound structural support and effective restraint of the infant. In the closed position, the mattress sections form a compact, easily carried assembly. A closing device such as a combination of straps and a snap is used which also forms a handle for carrying the mattress system. The mattress system is constructed of a foam material which is air permeable.

U.S. Pat. No. 6,704,953—Combination Sleeping Bag and Mat for Infants and Children

A device is provided to serve a dual purpose of a sleeping bag and sleeping or resting mat for users, e.g., infants and small children, that is easily transportable to an from day care centers or other places while the users are away from their home. The device includes a main body having a front, a back, two sides, a head end, a bottom end, a head section, a body section, and a pocket. The pocket is attached to the sides of the head section and has a slit extending laterally from side to side to receive the main body after it has been rolled up. The sleeping bag in this form is compact and ready for being transported or stored. The body section of the main body has mating zipper halves attached to each sides of the body section to permit parallel zippers to be engaged when the bottom end is adjacent the lateral slit in the pocket. This permits the caregiver to place a child on the front of the bag, bring the bottom end up over the child, and engage each of the parallel zippers without disturbing the child.

U.S. Pat. No. 8,214,949—Article of Bedding

An article of bedding comprising a bottom sheet having side walls thus to form a box sheet to be placed elastically over a mattress, and a top cover having its edges attached to those of the bottom sheet by means of a gusset. A sliding clasp fastener or the like is provided to attach the edges of the bottom sheet and top cover together respectively when the article is not in use. A pillowcase is permanently or removably attached to one end of the sheet and has an opening for insertion and removal of a pillow. The entire article, possibly excluding the pillow, is preferably of machine washable materials. An article made in this way ensures that the top cover which may contain a duvet, cannot slide off the bed inadvertently and therefore the occupant, most likely a child, is kept warm and safe from falling out of bed whilst having freedom of movement within the enclosure formed by the bottom sheet and top cover.

U.S. Pat. No. 10,736,300—Dog Mattress

A foam-based dog bed with no loose fiber comprising 5 components: 4 identical bolsters and 1 internal mattress is described. Both the internal mattress and bolsters may be comprised of 2-layers of different foam qualities. The foam pieces are wrapped in foam sheaths to make stuffing and un-stuffing into the outer fabric cover easier. The outer fabric cover is comprised of a top fabric, border fabric and bottom fabric. The top fabric incorporated specifically tailored wrinkles to allow a dog to dig, scratch, and prepare their bed. On the bottom panel of the dog bed is an outer perimeter zipper. The outer zipper starts and stops at a zipper pocket, which also serves as a hinge to open/close the bottom panel. The zipper pocket holds the zipper pull to prevent a dog from biting at it.

### US Application No. 2004/0231604—Pet Bed

A pet bed of the type having two cushions, each having one straight edge which connects to a straight edge strip corresponding in length to each cushion, allowing straight strip to act as a hinge to facilitate proper closure when cushions are placed together to form base and cover.

### US Application No. 2005/0211175—Traveling Pet Bed

An improved portable or traveling pet bed has a generally laminar panel that is at least partially covered on one side with material adapted to be comfortable to a pet lying on the panel. At least one hinge member is formed in the panel and divides it into first and second portions on each side of the hinge member. The first and second portions of the panel can be folded toward one another into a closed position.

### US Application No. 2006/0272581—Modular Pet Bed Assembly

An improved pet bed assembly includes a water resistant outer cover defining an enclosed space and a removable blanket that is removably attached to the exterior of the outer cover. The removable blanket is preferably constructed so as to be completely removable from the outer cover for washing and replacement and is further preferably constructed so as to be reversible, with an attachment mechanism that permits it to be secured to the outer cover with either surface facing the pet. An inner bed assembly is positioned within the enclosed space that preferably includes a perimeter bolster portion and an interior cushion portion. The perimeter bolster cushion has a greater height than the interior cushion portion and its uncompressed state and is less compressible than the interior cushion. The interior cushion portion preferably includes a first cushioning material positioned within a first compartment that resists lateral displacement during use, which provides constant stable cushioning to the pet honorable conditions as well as a second laterally displaceable cushioning material within a second, upper compartment that permits the pet to burrow into and nest comfortably on the pet bed assembly.

### US Application No. 2007/0245494—Convertible Pillow System and Associated Methods

A convertible pillow system includes an enclosing bottom member moveable between folded and unfolded positions, and at least one bumper member carried by the enclosing bottom member. The enclosing bottom member may have a substantially arcuate shape. Further, the enclosing bottom member and the at least one bumper member may form an enclosed area when the enclosing bottom member is in the unfolded position. The enclosing bottom member and the at least one bumper member may form a pillow when the enclosing bottom member is in the folded position. The least one bumper member includes a first portion that is fixedly connected to the enclosing bottom member, and a second portion that is detachably connected to the enclosing bottom member.

### US Application No. 2007/0275827—Yoga Mat

Improvements on mats for practicing yoga are presented. The mats typically provide improved balance, stability, relief of joint and knee pain, and/or improved grip, among other advantages. One particular mat has an upper surface with protrusions, such as knobs, to provide a feeling of acupressure massage to the user. The mat may be continuous and rolled up for storage, or may be divided into sections and folded. A layer of foam may be provided for cushioning, and the foam may optionally be a memory foam. Alternative embodiments include a mat without the protrusions on the upper surface, a mat with cushioning that has an undulating or otherwise irregular surface, and a mat that has no central foam but which is made of a single material.

### US Application No. 2011/0290834—Launderable Multi-Purpose Foldup Device

The invention relates to a convertible cushion that may be used as a blanket in an unfolded configuration or used as a cushion or bed in a folded configuration. One use of such a device relates to a fully washable pet bed. When folded, the convertible cushion may be used by a pet as a bed. When unfolded, the convertible cushion may be used as a blanket. Additionally, the device is constructed of material that is fully washable so that it may be washed in a typical household washing machine when in the unfolded position and fully cleaned. For some configurations, the convertible cushion may further be used in a pocketbook mode, a backpack mode, and a sleeping bag mode (by combining two or more convertible cushions).

### US Application No. 2012/0199075—Multi-Layer Pet Bed

A pet bed having an outer fabric layer which defines its shape. The fabric layer encases at least two distinct regions. A first regions comprises a fiber filled bolster and the second region comprises memory foam.

### US Application No. 2016/0088951—Combination Foldable Mattress and Ottoman

A high-end multifunctional mattress. The tri-fold design enables the mattress to fold easily and quickly into three equally sized stacked and attached parts. The tri-folded mattress stack can be zippered into a fabric cover designed to enclose the mattress snugly and form an ottoman.

### US Application No. 2017/0224138—Launderable Foldup Device

The invention relates to a convertible cushion that may be used as a blanket in an unfolded configuration or used as a cushion or bed in a folded configuration. One use of such a device relates to a fully washable pet bed. When folded, the convertible cushion may be used by a pet as a bed. When unfolded, the convertible cushion may be used as a blanket. Additionally, the device is constructed of material that is fully washable so that it may be washed in a typical household washing machine when in the unfolded position and fully cleaned.

For some configurations, the convertible cushion may further be used in a pocketbook mode, a backpack mode, and a sleeping bag mode (by combining two or more convertible cushions).

### BRIEF SUMMARY OF THE INVENTION

In accordance with one aspect of the invention, a first embodiment of a modular pet bed includes a foldable pet bed that is adapted to be spread out like a blanket in a single layer, or to be folded up and zipped or otherwise attached to form a multi-layer pet bed. The pet bed, in its compact, folded configuration includes a foldable outer layer, a foldable inner layer, and an attachment means such that the outer and inner layers may be folded and secured together to form a bed. The foldable outer layer is made from a durable, washable material. The foldable inner layer is also made from a durable, washable material and sits within the outer layer to create a cushion. When the outer and inner layers are folded and secured, a pet bed is formed. When the user is ready to wash the pet bed, she may collapse the bed by unfastening the attachment means around the perimeter of the bed. An optional, detachable layer may be added to the inner layer to provide additional cushion. An optional, detachable layer may be added to the outer layer such that a pet would lay on the detachable layer, and when the bed needs cleaning, the user would only have to detach the additional layer and wash it. The present invention can come in various sizes to accommodate various sized dogs or other pets.

In accordance with another aspect of the invention, the modular pet bed may instead include a foldable outer layer with a closure device, such as a zipper, extending about its perimeter, together with one or more foldable inner layers that are wholly detached from the outer layer. In this embodiment, the detached inner layers are positioned on top of the outer layer in aligned relation, after which the outer layer is folded in half so that the inner layers are sandwiched between opposed portions of the outer layer. The closure device is then secured around three sides of the outer layer to fully retain the detached inner layers inside the bed. This embodiment provides the advantage of allowing the bed to be broken down into multiple separate panels for ease of washing, particularly useful when a user has a small washing machine or dryer. In addition, the detached inner layers may serve as stand-alone blankets for pets or people when removed from the outer layer, and additional detached layers may be inserted into the outer layer if desired to increase cushioning.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of the multi-layer modular pet bed, wherein the pet bed is shown in its folded, compact state, and further showing a zipper around three sides thereof for securing the pet bed in the folded, compact state;

FIG. 2 is a top view of one embodiment of the multi-layer modular pet bed, wherein the pet bed is shown in an open, unzipped state, and wherein one corner of the foldable inner layer is folded back onto itself;

FIG. 3 is a top view of one embodiment of the multi-layer modular pet bed, wherein the pet bed is shown in an open, unzipped state, and one panel of the foldable inner layer is disposed in an open position adjacent one side of the foldable outer layer;

FIG. 4 is a top view of one embodiment of the multi-layer modular pet bed, wherein the pet bed is shown in an open, unzipped state, and both panels of the foldable inner layer are disposed in an open position adjacent the respective, opposed sides of the foldable outer layer;

FIG. 5 is a perspective view of one embodiment of the multi-layer modular pet bed, wherein the pet bed is shown in its folded, compact state, and a removable protective outer layer is attached to a top portion of the pet bed;

FIG. 6 is a top view of one embodiment of the multi-layer modular pet bed, wherein the pet bed is shown in an open, unzipped state, and wherein one corner of the foldable inner layer is folded back onto itself, and wherein a removable additional layer is positioned over the foldable inner layer, in order to provide additional cushioning for the pet bed;

FIG. 7 is a top view of one embodiment of the multi-layer modular pet bed, wherein the pet bed is shown in an open, unzipped state, and both panels of the foldable inner layer are disposed in an open position adjacent the respective, opposed sides of the foldable outer layer, and wherein each layer includes an inner chamber for receiving additional filling material through an opening therein, and wherein each opening includes a zipper for securing the opening in a closed position; and

FIG. 8 is a perspective view of one embodiment of the multi-layer modular pet bed, wherein the pet bed is shown in its folded, compact state, and further, shows a pair of handle members being disposed on an outer portion of the foldable outer layer for handling and transport purposes; and

FIG. 9 is a perspective view of one embodiment of the multi-layer modular pet bed, wherein the pet bed is shown in its folded, compact state, and a removable protective layer slips over the entirety of the pet bed and includes a zipper for securing the protecting layer onto the pet bed.

FIG. 10 is a top view of another embodiment of the multi-layer modular pet bed, wherein two panels of the foldable inner layer are disposed on either side of the foldable outer layer, wherein the two foldable inner layer panels are disposed in an open position and are wholly detached from the foldable outer layer having a zipper that extends around the outer perimeter thereof; and

FIG. 11 is a perspective view of the embodiment of the multi-layer modular pet bed shown in FIG. 10, wherein the two foldable inner layers are positioned within the foldable outer layer, and wherein the modular pet bed is shown in a partially closed position.

### DETAILED DESCRIPTION OF THE INVENTION

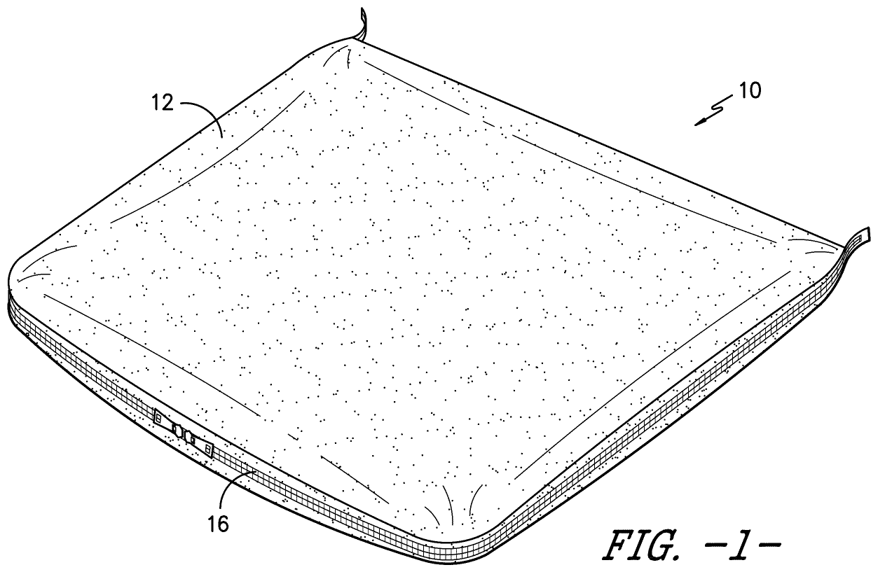

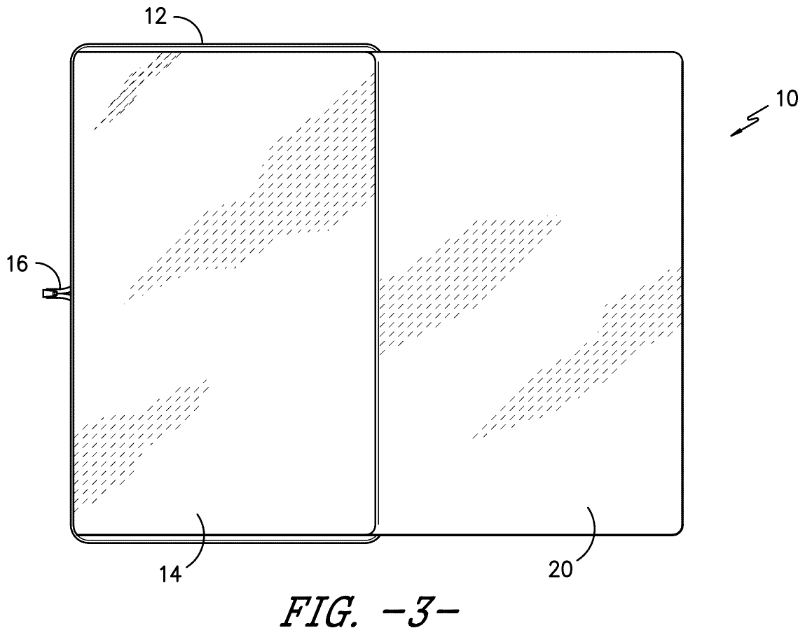

The present invention includes, in a first embodiment, a multi-layer modular pet bed 10, as shown in FIGS. 1-8, and includes a foldable outer layer 12, a foldable inner layer 14, and an attachment means 16, such as a zipper, buttons, hook and loop fasteners, or any other suitable means for releasable attachment. The foldable inner layer 14 fits within the foldable outer layer 12 when the pet bed is in a compact state, as shown in FIG. 1, and is preferably attached to the foldable outer layer 12 by attachment means 18, such as stitching, a zipper, buttons, or hook and loop fasteners.

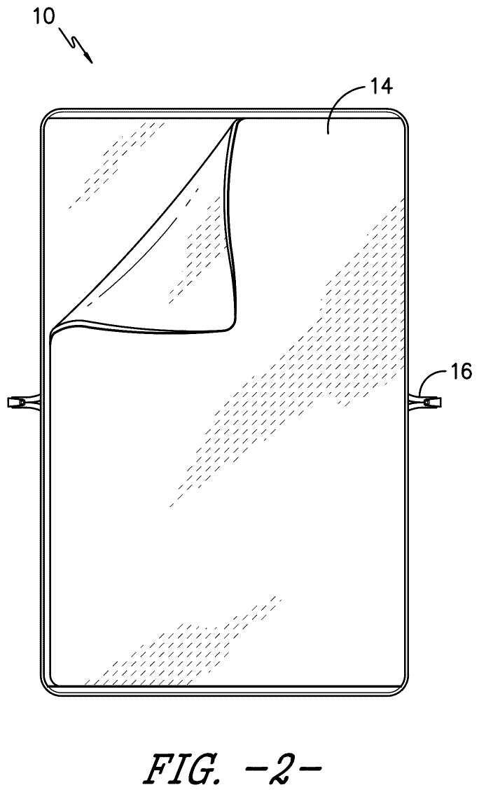

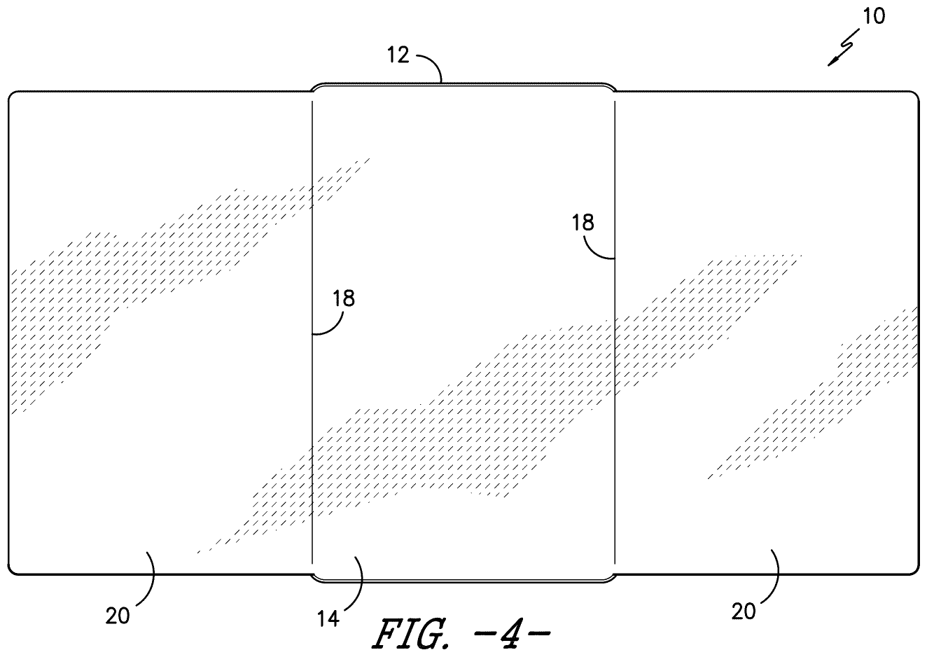

In a preferred embodiment, the foldable inner layer 14 consists of two panels 20 attached to opposed sides of the foldable outer layer 12, as shown in FIG. 4. The foldable outer layer 12 is preferably slightly wider than the foldable inner layer 14 such that the foldable inner layer 14 fits within the foldable outer layer 12. In order to secure the modular pet bed into its folded, compact configuration, the inner foldable layer panels 20 are folded onto the inner surface of the foldable outer layer, so that the foldable outer layer is underneath the two foldable inner layer panels, as shown in FIG. 2. Then, the three layers are folded in half, so that the foldable outer layer encompasses the foldable inner layer panels, and the zipper (or other attachment means) is closed or otherwise secured about 3 sides of the modular pet bed, as shown in FIGS. 1, 5 and 8.

Both the foldable outer layer 12 and the foldable inner layer 14 are made of a durable, washable, preferably soft, cushioned material. In a preferred embodiment, the layers may include a thick pile textile material to provide cushioning and insulation, and it should be understood that the layers may be made from any suitable material, including but not limited to Sherpa fabric, which is typically made from polyester, acrylic, or cotton and is sometimes called ‘faux shearling,’ named for its resemblance to the wool-lined clothing worn by the Sherpa people of Nepal. Sherpa mimics the bumpy texture of sheep's wool

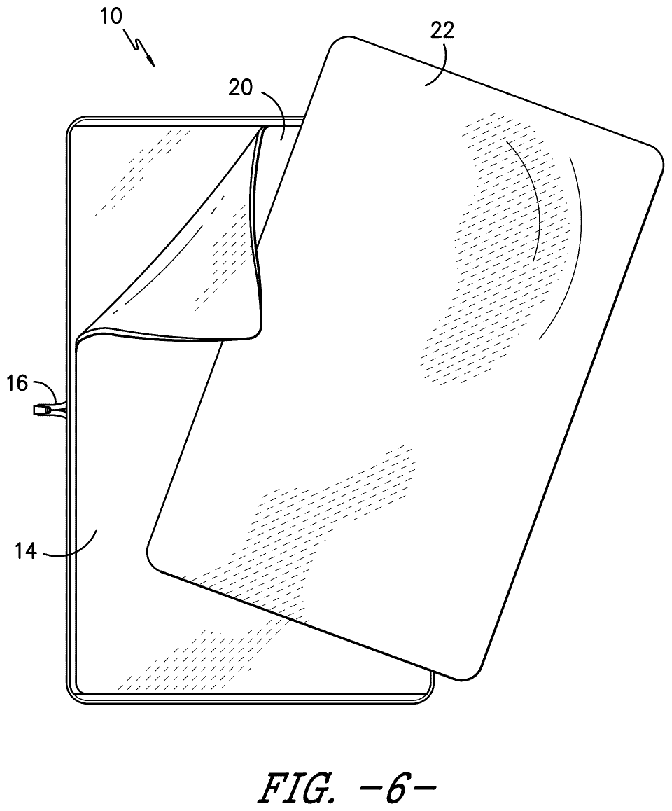

In one embodiment, one or more additional layers 22 may be inserted with the foldable inner layer 14, or within the foldable outer layer 12 to provide more cushion to the multi-layer modular pet bed 10, as shown in FIG. 6. The additional layer 22 is preferably made from the same material as the foldable inner layer 14, although it is contemplated that the additional layer may be made from a different material.

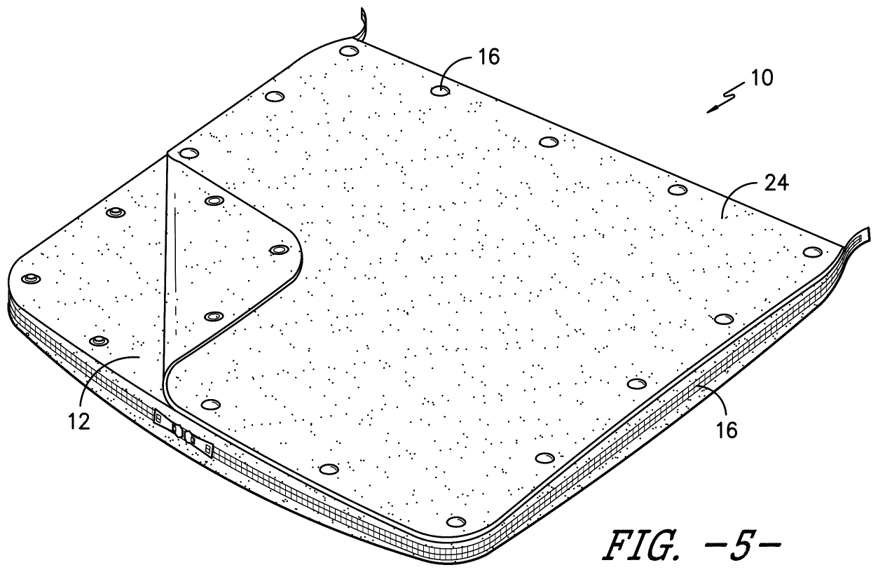

A removably attachable protective layer 24 may be attached to the foldable outer layer 12 by attachment means 16, such as a zipper, buttons, or hook and loop fasteners, as shown in FIG. 5. The protective layer 24 allows the multi-layer modular pet bed 10 to stay clean, so the user would only have to wash the protective layer 24.

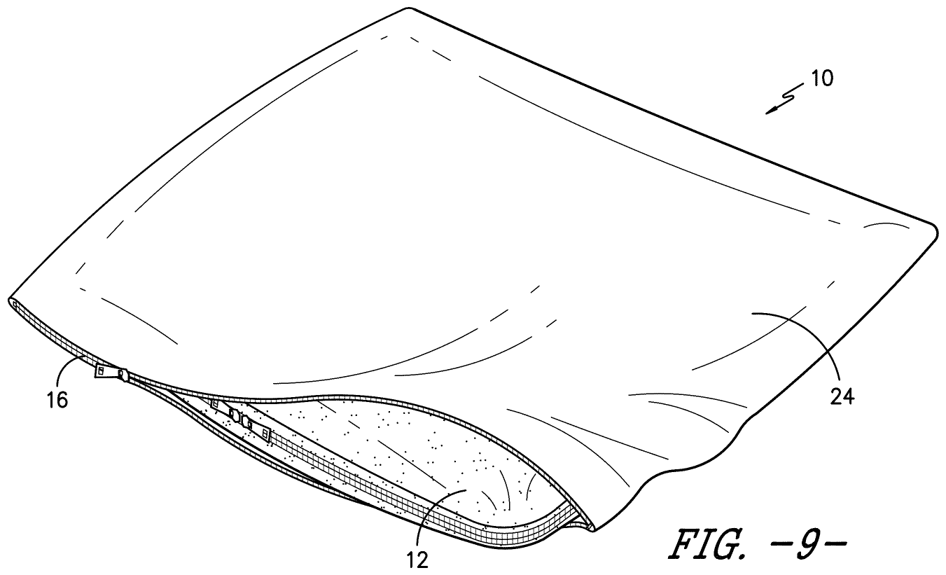

Alternatively, the protective layer 24 may form a casing that fits over the entire pet bed, similarly to a pillowcase being removably placed around a pillow in the traditional manner, as shown in FIG. 9. In this embodiment, the protective layer includes an opening at one end for receiving the pet bed, and may optionally include closure means about the opening, such as a zipper, buttons, hook and loop fasteners, and the like, in order to maintain the opening in a closed position while disposed about the pet bed.

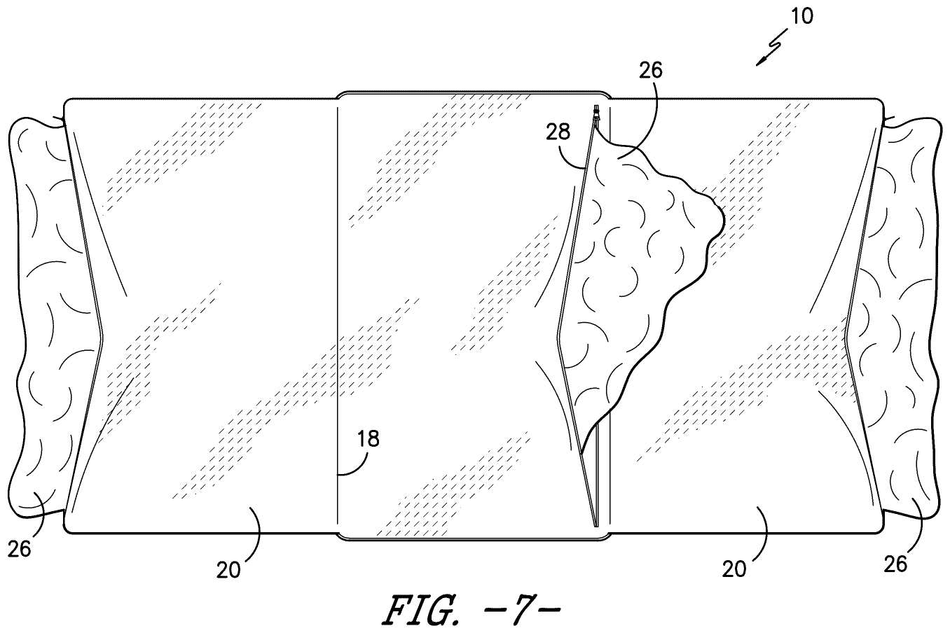

In another embodiment, the foldable inner layer 14, the additional inner layer(s) 22 and/or the foldable outer layer 12 may include an inner chamber for receiving soft padding material 26 which may be secured within any or all of these layers by an attachment device 28 (such as a zipper or the like) positioned on one side of the layer, as shown in FIG. 7. If a user desires to increase the amount of cushion within the pet bed, a user may add additional soft padding material 26 to the foldable inner layer 14 by opening the foldable inner layer 14 using the attachment device 28. The soft padding material 26 may be any suitable material, such as foam, expanded polystyrene beads (which is the fill material typically used inside of traditional bean bags), or any other desirable material that provides additional cushioning.

It is also contemplated that the foldable inner layer 14 may be removable from the foldable outer layer 12, so that the foldable outer layer may be washed without having to wash the foldable inner layer. In an alternate embodiment, a handle 30 can be added to the multi-layer pet bed 10 for allow for easy travel. While the invention has been described as being used as a pet bed, it should be understood that the multi-layer modular pet bed could also be used as a blanket in its unfolded configuration, or a pillow in its folded configuration, and may be particularly useful during travel.

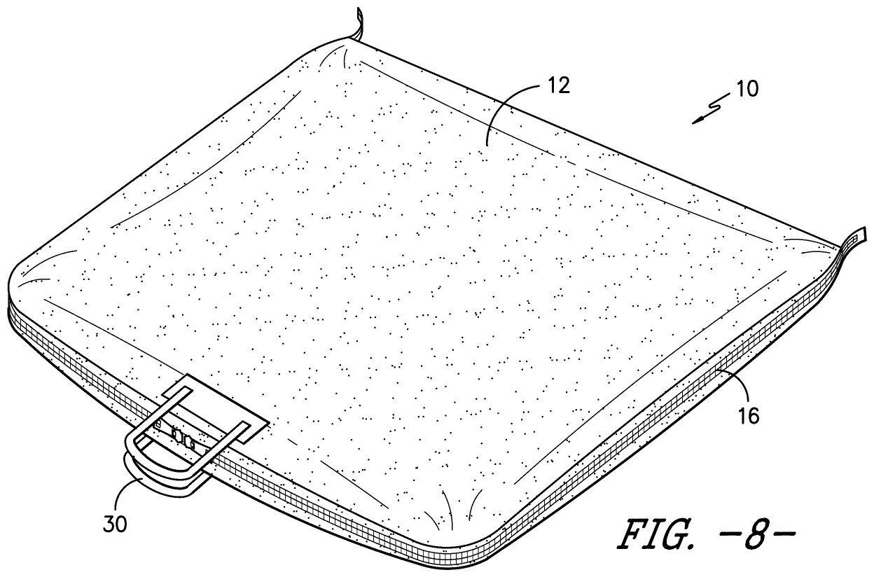

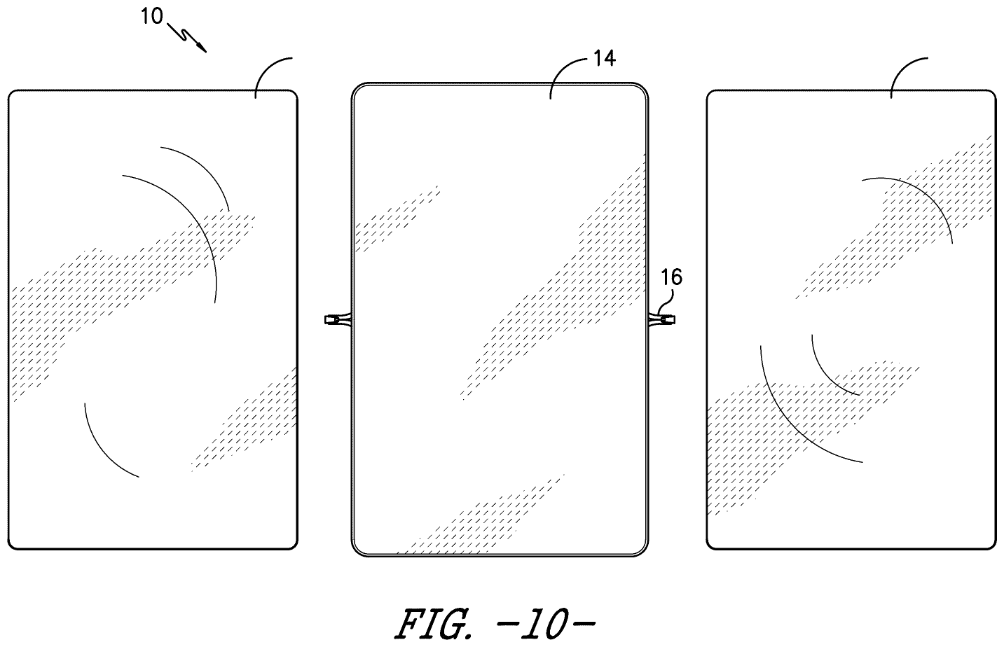

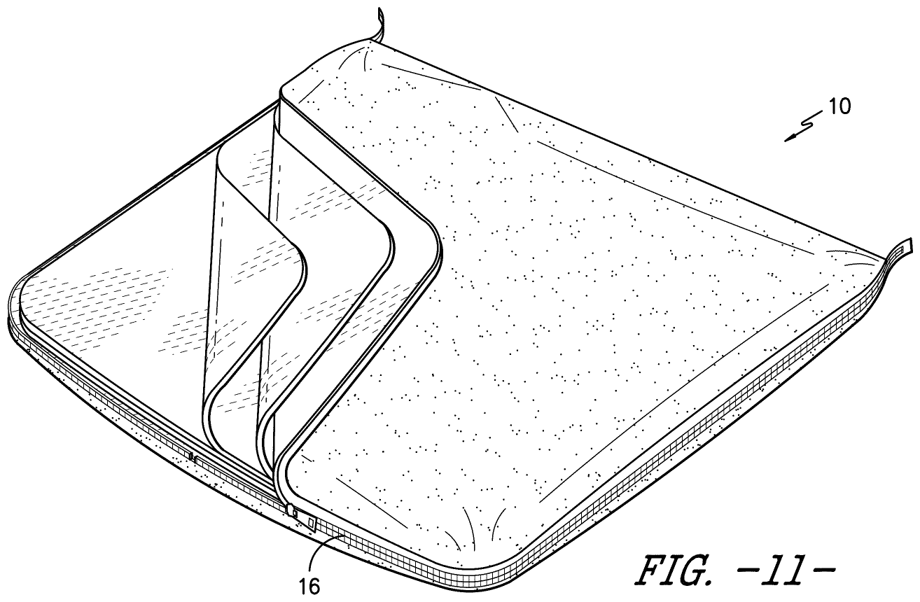

In another embodiment, as shown in FIGS. 10-11, the multi-layer modular pet bed 10 includes a foldable outer layer 12 having a zipper 16 that extends about the outer perimeter thereof. In this embodiment, a pair of foldable inner layers 14a, 14b are wholly detached from the foldable outer layer 12, so that three separate and independent panels are used to form the modular pet bed 10, as shown in FIG. 10. The two detached inner layers 14a, 14b may be positioned on top of the foldable outer layer 12 in aligned relation, and then the foldable outer layer 12 is folded in half such that the two inner layers 14a, 14b are sandwiched between opposed portions of the outer layer 12, as shown in FIG. 11. The zipper 16 may then be secured about three sides of the outer layer 12 in order to enclose the inner layers 14a, 14b and form a compact modular pet bed 10, in a manner similar to the embodiments illustrated in FIGS. 1 and 8.

One advantage of this embodiment is that the modular pet bed 10 may be broken down into three (or more, if desired) separate panels for washing, which is particularly advantageous if a user has a small washing machine or dryer. It is contemplated that additional foldable inner layers 22 may also be positioned within the foldable outer layer 12, as desired, to increase the amount of cushioning within the modular pet bed 10. Alternatively, a single detached inner layer 14 may be inserted into the foldable outer layer 12, as desired. Furthermore, when the detached inner layers 14a, 14b are removed from the outer layer 12, they may themselves serve as stand-alone blankets for pets or people.

It should also be understood that other features described herein and shown in the accompanying drawings may be incorporated into this multi-layer embodiment, even where each panel is detached and separate from the others. For example, one or more of the inner layers 14a, 14b may include an inner chamber 26 for receiving additional filling material, such as foam or beads, through an opening secured by a zipper 28, as shown in FIG. 7. This embodiment may also include one or more handles 30 secured to the outer layer 12 for transport, as illustrated in FIG. 8, or an outer protective layer 24 disposed over the folded pet bed 10, as shown in FIGS. 5 and 9.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A modular pet bed comprising:
a foldable outer layer having a perimeter and a closure device extending continuously along substantially the entire perimeter; and
at least one foldable inner panel that is wholly detached from said outer layer and dimensioned to be received within said foldable outer layer;
wherein, in a folded configuration, said outer layer is folded over said inner panel and said closure device is secured along said perimeter so that said inner panel is fully retained within said folded outer layer, thereby forming a cushioned pet bed.

2. The modular pet bed of claim 1, further comprising a pair of detached inner panels, each sized to substantially align with said outer layer when laid flat thereon, wherein said outer layer and said pair of inner panels are foldable together such that said inner panels are sandwiched within said outer layer when said closure device is secured.

3. The modular pet bed of claim 1, wherein at least one inner panel includes an inner chamber and a closure for receiving additional padding material.

4. The modular pet bed of claim 1, wherein said closure device comprises a zipper extending about said entire perimeter.

5. The modular pet bed of claim 1, further comprising a handle secured to said outer layer for carrying the folded pet bed.

6. The modular pet bed of claim 1, further comprising a removable protective sleeve dimensioned to encompass the folded pet bed.

7. The modular pet bed of claim 1, wherein said inner panel is selectively usable as a blanket when detached from the outer layer.

8. The modular pet bed of claim 1, wherein said bed further comprises a plurality of said detached inner panels received within said outer layer to increase cushioning.

9. A modular pet bed comprising:
a generally rectangular foldable outer layer including a perimeter closure device extending continuously along at least three adjacent edges;
a first inner panel hingedly attached to a first edge of said outer layer; and
a second inner panel hingedly attached to an opposite edge of said outer layer;
wherein said first and second inner panels are foldable over said outer layer in stacked relation, and said outer layer is foldable in half to enclose said stacked inner panels, said closure device securing said outer layer in a closed, cushioned configuration.

10. The modular pet bed of claim 9, wherein said closure device extends along all four edges of said outer layer.

11. The modular pet bed of claim 9, wherein each inner panel includes an internal chamber for receiving padding material.

12. The modular pet bed of claim 9, further comprising a removable protective layer attached to an outer surface of said outer layer.

13. The modular pet bed of claim 9, wherein said outer layer and said inner panels are formed of washable textile material selected from the group consisting of Sherpa fabric, fleece, or polyester.

14. The modular pet bed of claim 9, further comprising a handle disposed on an exterior portion of said outer layer for carrying.

15. A modular pet bed comprising:
a foldable outer layer including a closure device extending along substantially the entire perimeter thereof;
at least one foldable inner panel positioned within said outer layer when in a folded configuration; and
a removable protective casing configured to encompass said outer layer and said inner panel in said folded configuration, said protective casing including an opening and a closure for selectively enclosing said pet bed within said casing.

16. The modular pet bed of claim 15, wherein said protective casing includes a zipper extending along said opening.

17. The modular pet bed of claim 15, wherein said protective casing is dimensioned to fully enclose the folded pet bed similar to a pillowcase.

18. The modular pet bed of claim 15, further comprising at least one removable cushioning insert adapted to be positioned within said inner panel.

19. The modular pet bed of claim 15, wherein said outer layer further comprises at least one handle for transport.

20. The modular pet bed of claim 15, wherein said inner panel is detachable and usable as a blanket separate from the folded pet bed.
